(19) United States
(12) Patent Application Publication
(10) Pub. No.: US 2008/0144505 A1
(43) Pub. Date: Jun. 19, 2008

(54) Method and Apparatus for Bitrate Reduction

(76) Inventors: Michael Anthony Isnardi, Plainsboro, NJ (US); Arkady Kopansky, Havertown, PA (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/935,322

(22) Filed: Nov. 5, 2007

Related U.S. Application Data
(60) Provisional application No. 60/856,774, filed on Nov. 3, 2006.

(51) Int. Cl. H04L 12/56

(52) U.S. Cl. 370/235

(57) ABSTRACT

A method and apparatus for reducing the bitrate of a given datastream is provided. The bitrate of a given datastream is reduced by altering the payload of an incoming packet, while still providing sufficient data as to not cause a malfunction within the receiving node. The altered payload represents data which will trigger commonly used error concealment methods, within the receiving node. The determination as to which packets undergo alteration is based on a relationship between network congestion and the priority of a given packet. A packet's priority is measured in terms of its effect on the regeneration of high quality signal. As the need to reduce the bitrate of a given datastream increases, the occurrence of packet alteration increases.

### CROSS-REFERENCE TO RELATED APPLICATION

This application claims the benefit of U.S. Provisional Patent Application No. 60/856,774, filed Nov. 3, 2006, the contents of which is hereby incorporated by reference herein.

### GOVERNMENTAL RIGHTS IN THIS INVENTION

The U.S. Government has a paid-up license in this invention and the right in limited circumstances to require the patent owner to license others on reasonable terms as provided for by the terms of 14841 70NANB3H3053 awarded by the National Institute of Standards and Technology

### BACKGROUND OF THE INVENTION

1. Field of the Invention

Embodiments of the invention are related to the field of broadband network architecture and, more particularly, to the management of network congestion.

2. Description of the Prior Art

Originally built to carry voice communications, the public switched telephone network has recently been employed to perform functions well beyond its original design. With the boom in demand for broadband Internet access, many telephone companies have developed innovative methods of carrying large amounts of data over their network infrastructure, which in certain areas, is decades old. The telephone companies have met this challenge by offering many customers digital subscriber line (DSL) service, which makes use of previously unutilized high frequencies within the current last mile connect. With most traditional telephone companies now offering voice and data access, many would like to also provide video content to their customers over the telephone network.

Given the bandwidth constraints on last mile under which telephone companies operate, innovative methods must be devised in order to allow for video broadcast over the bandwidth-deprived last mile of the telephone network. Instead of broadcasting all stations to all customers, as some telecommunications providers do, some telephone providers typically only broadcast the specific stations which a customer requests. Even given the bandwidth constraints of the telephone network's last mile connections, a single DSL line could carry up to four standard-definition (SD) video stations in addition to voice and data.

One issue currently plaguing the push to effectively provide video over the telephone network is the implementation of a method which will provide a consistent video image even during periods of high congestion in the line connecting the customer premises to the telephone company. The point at which video stations are multiplexed onto a customer's DSL line is typically referred to as a digital subscriber line access multiplexer (DSLAM). When a customer requests a change to the current television station which he is viewing, the DSLAM responds by broadcasting the requested television station onto the customer' DSL line. It is the responsibility of the DSLAM to ensure that a high quality signal for each requested station is broadcast over the correct user's line. An important issue is ensuring that the DSLAM broadcasts each station in a high quality and usable form. This task becomes strained when the amount of data required to generate the given video stream exceeds the capacity of the last mile connection to the customer premise (e.g., customer's home).

One method of providing a consistent broadcast signal is to code the outgoing bitstream using a constant bitrate (CBR). When utilizing a CBR encoding scheme, the entire bandwidth of a given medium is segmented into defined channels. Each channel will have a defined amount of bandwidth which is provisioned exclusively for the use of the given channel. In the case of broadcasting video, a single requested video stream might be assigned a given channel. The use of a CBR encoding ensures that each video stream being broadcast onto a customer line will have a given amount of available bandwidth. With a known amount of available bandwidth for each channel, the DSLAM can more easily provide users with a properly groomed signal, or in other words, a signal of consistent quality. The use of constant bitrates does, however, decrease efficiency in certain ways. In instances where a given channel is not being fully utilized, the DSLAM is required to fill the CBR with stuffed bits (i.e., placeholder bits that are added to maintain the CBR). Thus, in order to achieve greater efficiency and often higher picture quality, variable bitrate (VBR) encoding is often used. In VBR encoding, the size of the outgoing packets are dependant on the size of the incoming datastream. In instances where the bitrate of the data being broadcast to a given user is low, the output line will not be used to its full capacity. However, when the bitrate of the data being requested by a user is high, then the output stream might exceed capacity.

There are different approaches to take when the amount of data requested by a user exceeds the given capacity of an user's access line. One method is for the congestion management unit to intentionally stop forwarding incoming packets to their destination node and delete them, until the bitrate decreases to a level that is within the capacity of the output line. This method, commonly referred to as dropping packets, results in diminished picture quality and can cause certain set top boxes (STBs) or digital TVs (DTVs) to malfunction. Another method, sometimes referred to as “denting”, prioritizes packets based on their importance within the regeneration of a given image, and drops the lowest priority packets. This again can result in decreased picture quality and set top box malfunctions. Thus, there is a need for a method and apparatus which can effectively reduce the bitrate of a given datastream with minimal noticeable reduction in picture quality or node (e.g., set top box) malfunctions.

### SUMMARY OF THE INVENTION

Embodiments of the invention are directed to improved methods and systems of reducing the bitrate of a given datastream which allows for regeneration of higher quality images while decreasing the occurrences of set top box malfunctions. The method and apparatus can be implemented into a network that might be utilizing different generations of receiving nodes. Unlike current methods of bitrate reduction, which simply drop packets when network congestion requires, the current invention selectively alters the content of some packets in order to reduce the bitrate while still providing the receiving node with a usable packet. Known concealment methods can be utilized, which allows for the reduction of packet size without creating a situation where older legacy receiving nodes can not adequately process a given altered packet. By way of certain embodiments, more intelligent receiving nodes can utilize more advanced error concealment methods to more elegantly process altered packets.

Also disclosed, is a method of managing a datastream traveling over a data network, where the method receives a data packet, in which the data packet includes header information and a data payload. Following the receipt of the packet, the method determines both the priority level of the data packet as well as the congestion level within the network. The data payload of the packet is replaced with a shorter data payload, to form a modified data packet. The modified packet is then forwarded onto the data network.

An embodiment of the present invention also includes a apparatus for managing a datastream traveling on a data network, where the apparatus receives a data packet, in which the data packet includes header information and a data payload. Following the receipt of the packet, the apparatus determines both the priority level of the data packet as well as the congestion level within the network. The data payload of the packet is replaced with a shorter data payload, to form a modified data packet. The modified packet is then forwarded onto the data network

### BRIEF DESCRIPTION OF THE DRAWINGS

The above and other objects and advantages of embodiments of the invention will be apparent upon consideration of the following detailed description, taken in conjunction with the accompanying drawings, in which like reference characters refer to like parts throughout, and in which:

FIG. 1 is a diagram of a system for altering the size of an incoming packet to reduce network congestion, in accordance with embodiments of the invention;

FIG. 2 is a flow diagram of a process of manipulating the size of a data packet based on the current state of network congestion, in accordance with embodiments of the invention;

FIG. 3 is a schematic diagram of a process of selectively altering data frames from within a data stream, in accordance with embodiments of the invention;

FIG. 4 is a schematic diagram of a process of creating a short packet based on an original packet of greater size, in accordance with embodiments of the invention;

FIG. 5 is a schematic diagram showing the difference between an original fame and a modified frame, in accordance with embodiments of the invention; and

FIG. 6 is a schematic diagram of a frame coding scheme which allows for differentiation between an intentionally shortened frame and certain original frames, in accordance with embodiments of the invention.

### DETAILED DESCRIPTION OF THE INVENTION

Embodiments of the present invention are directed to methods and systems for reducing data bitrates without creating a significant diminution in the quality of service. For the purpose of clarity, and not by way of limitation, illustrative views of the present invention are described with references made to the above-identified figures.

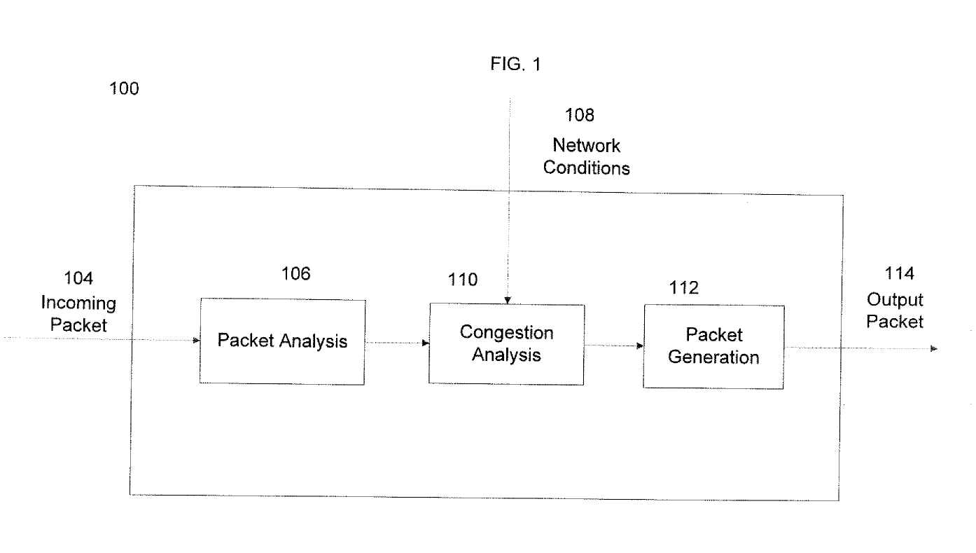

FIG. 1 describes a system diagram in which the content of a packet is analyzed and possibly altered based on the level of congestion within the network. By way of system 100, an incoming packet 104 arrives at the congestion management unit 102. When the system 100 is utilized to deliver data over a DSL connection, the congestion management unit 102 can be a DSLAM or like device. If the system 100 is utilized to aid in the delivery of data over a cable network, the congestion management unit can be a “grooming device”, as is known to those skilled in the art, within the cable network. Irrespective of the mode with which the data is being transmitted, the congestion management unit can be any device which acts to monitor or control network traffic.

Once the incoming packet 104 has reached the congestion management unit 102, the packet undergoes packet analysis 106. During the process of packet analysis 106 the packet is examined to determine the packet's level of priority. A higher priority packet is one in which the loss of the packet would result in cascading detriment to the reconstruction of a datastream. In the case of a video bitstream, the highest priority packet is an Intra Frame (I-Frame) or other frame type which derives its data independently, but upon which other packets rely. The loss of such a frame can have an adverse effect to all subsequent frames which rely on the information represented in the I-Frame. The packet type with the lowest level of priority is the non-reference bi-directional or bi-predictive frame (B-Frame), or other frame type which does not act as a reference frame for any other frame. Other frame types will fall within this range of priority, judged in light of the effect that the frame's absence would have on the quality of service. Once the incoming packet 104 has been analyzed 106 to determine its priority level, the current system 100 determines the congestion level within the network. Network congestion conditions 108 are analyzed by the congestion management unit 102 to determine whether alterations must be made to an incoming packet 104. One method for analyzing the congestion level within a network is to monitor buffer levels associated with given output lines. When a given buffer level exceeds a predetermined threshold, it can be determined that congestion levels within the network warrant responsive action. If the congestion analysis 112 determines that there are no congestion concerns, then packets proceed unaltered into the proper queue or output line 114. In the event that there are congestion issues, the packet then proceeds to the packet generation step 110 at which point the packet is modified to better utilize the current network conditions. Packets which have low priority are more likely to be modified, or, in other words, to have their payload altered and reduced to make room for higher priority packets. Once the packets have been reformed, they exit the congestion management unit into the proper queue or appropriate output line 114.

The packet analysis 106, congestion analysis 110, and packet generation 112 steps, described in FIG. 1, could each be accomplished through individual packet analysis, congestion analysis and packet generation modules. These modules could be executed on a microprocessor, integrated into a single apparatus, or dispersed through a plurality of apparatuses. The functionality of each module could be controlled via software and/or firmware.

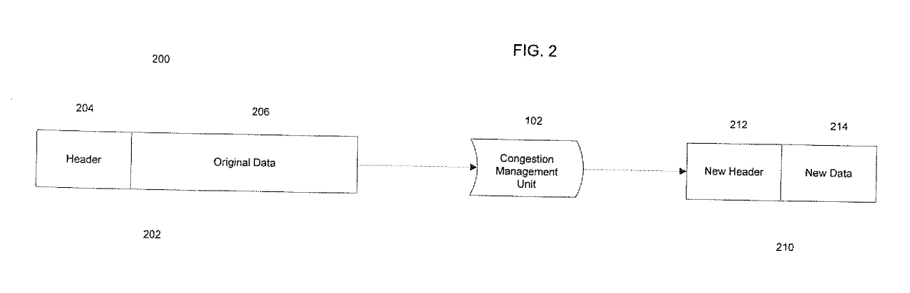

FIG. 2 illustrates a process of manipulating the size of a data packet based on network congestion. The incoming packet 202 is comprised of a header 204 and the original data 206. The header 204 contains information which facilities the packet reaching its final destination, so that upon arrival, the receiving node can properly utilize the packet. In the instance where the incoming packet 202 represents an Internet Protocol (IP) packet, the header might include IP, User Datagram Protocol (UDP), Real-time Transport Protocol (RTP), and Packetized Elementary Stream (PES) information. The content of the header information is dependent upon the type of packet and mode of transmission being utilized. In addition to the header 204, the incoming packet 202 also includes original data 206. The original data 206 contains the actual content which the user is either sending or receiving. For example, the original data could be a portion of a video stream. The method 200 proceeds when the incoming packet enters the congestion management unit 102. In the instance where the end user is connected to the network via DSL connection the congestion management unit may be a DSLAM. Alternatively, the congestion management unit 102 could be any device which aggregates network traffic and/or maintains line congestion. Based on the level of congestion within the network, the congestion management unit may alter the content for the incoming packet 202. The original data 206 is altered while still providing adequate data to allow the receiving node to reproduce the given data file without substantial decrease in quality of service. Information within the header field 204 of the incoming packet 202 may be altered to ensure that the information within the header field 204 accurately describes any changes which have been made to the original data field 206. Once the congestion management unit completes the process of analyzing the network congestion and reforming the new packet information, a short packet 210 exits the congestion management unit 102. This short packet 210 is comprised of a header field 212 as well as a new data field 214. The header field 212 contains the information which is required in order for the packet to reach its final destination while also ensuring that the receiving node can properly utilize the packet upon arrival. The information within the header field 212 of the short packet 210 can be significantly similar to the header field 204 of the incoming packet 202. The only alteration is the result of changes made to the short packet header 212 in order to guarantee that the header field 212 accurately describes any alteration made to the original data field 206. In order to increase processing speed, the system can precode the datastream to represents a short packet. In other words, the congestion management unit would have a predetermined bitstream which it would use as the payload for every short packet. Such precoding alleviates the need for a processor to repeatedly rebuild a frame which represents a short packet.

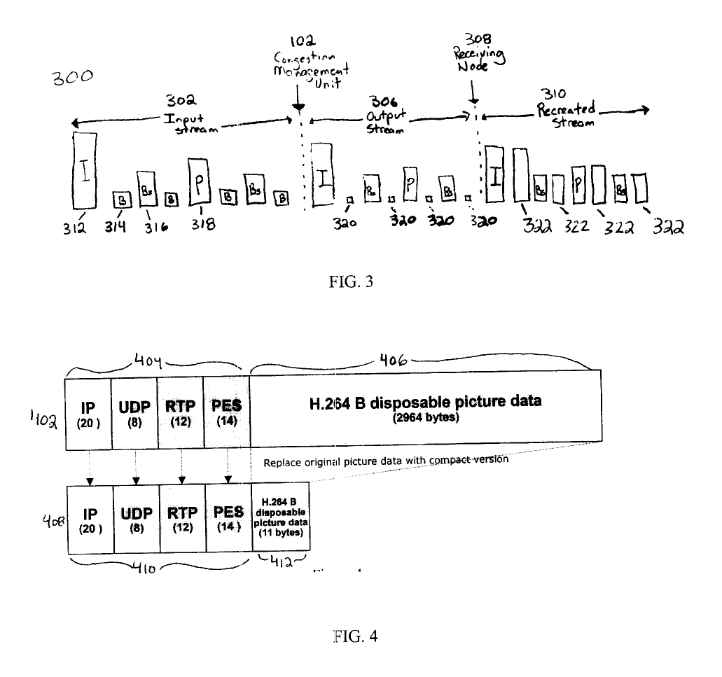

The congestion management unit can intelligently select which packets to modify in order to reduce any significant effects to the quality of service. FIG. 3 provides a visual representation of a video file datastream 300. The datastream 300 is segmented into three sections; Input stream 302, Output stream 306, and Recreated stream 310. The input stream 302 represents the unaltered datastream as it enters the congestion management unit 102. This stream is comprised of an I-Frame 312, predicted frame (P-Frame) 318, bi-predictive stored (Bs-Frame) 316, and B frames 314. The input stream 302 is in its unaltered state as it enters the congestion management unit 102. The congestion management unit 102 then alters the content of the input stream consistent with FIG. 2. The output stream 306 representing the altered version of the input stream 302 then exits the congestion management unit 102. As compared to the content of the input stream 306, the B-Frames 314 have been substituted for by skip frames 320 in the output stream 306. A skip frame, as is commonly know in the art, refers to a macroblock encoding scheme where, the data within the skip macroblock instructs the receiving node to execute some form of error concealment. This substitution reduces the overall size of the output stream 306. In this instance, the only frames having undergone size reduction are the B-Frames 314. Such a reduction would occur if network congestion dictated that only low priority packets be altered. In instances where a greater bitrate reduction is necessary, other frames of higher priority can be subject to alternation. After exiting the congestion management unit 102, the output stream 306 proceeds to the appropriate receiving node 308. Within the set top box 308, the output stream is reconstructed into the recreated stream 310. During the process of reconstruction, the set top box 308 can implement frame concealment techniques in order to compensate for any data lost as a result of the alteration which occurred at the congestion management unit 102. In the case of the current bitstream 300 the data within all B-Frames 314 has been eliminated. In order to recreate a bit stream which will produce an acceptable quality of service, the set to box may implement error concealment functions based on the information coded within the skip frames 320. In the current example, the skip frames 320 call for the set top box 308 to recreate the previous frame. This process produces a recreated datastream 310 in which every bi-directional frame is substituted for by a duplicate of the previous frame(322). In many instances, this duplication will not result in a perceivable diminution of video quality. FIG. 3 illustrates one possible method of error concealment. Embodiments of the invention include other forms of error concealment that one skilled in the art, as informed by the current disclosure, would find applicable in this situation.

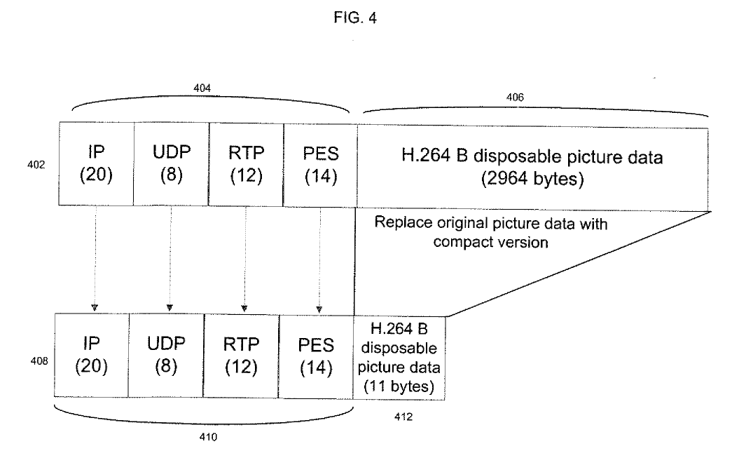

FIG. 4 illustrates, at the bit level, the difference between an original packet 402 and a short packet 408. FIG. 4 utilizes an IP packet, which is part of a H.264 (i.e., MPEG 4) data stream, to demonstrate the difference between a original and a short packet, but the general principle underlying this difference holds true for many different encoding protocols. The original packet 402 is comprised of 3018 bytes of which 54 bytes signify the original header 404 while 2964 bytes represent the original data 406. When the packet is altered by the congestion management unit, the amount of header information remains constant while the amount of data information is greatly reduced. In the current example, the size of the original data 406 is 2964 bytes while the size of the altered data 412 is 11 bytes. This reduction or the size of the packet's payload allows the congestion management unit to reduce the bitrate of a datastream. Despite the fact that the amount of data within the header remains unchanged, the content within the head has been slightly altered. Given that the length of the altered packet 408 is significantly shorter than the original packet 402, the length information coded within the original header 404 must be altered to accurately reflect the change in packet length.

It is beneficial when altering the data portion of a given packet to ensure that the altered packet can be processed by the receiving node. One technique for reducing the bitrate of a datastream is to drop packets when congestion levels rise. This approach can create problems for certain receiving nodes which are expecting the arrival of a given sequence of packets. As a result of this unexpected event, some receiving nodes may malfunction or hang up. A different approach is to provide the receiving node with a packet which is smaller in size but does not interrupt the sequencing pattern.

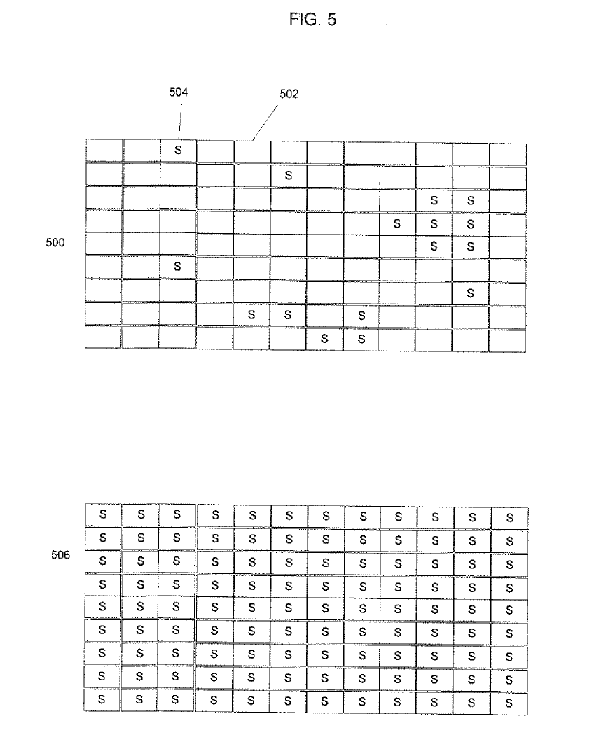

FIG. 5 illustrates a way in which a data packet can be altered in order to reduce its size while still maintaining a form consistent with a receiving node's expectations. In FIG. 5 the original frame 500 represents the data portion of an original packet. Each square within the original frame 500 represents an individual macroblock. As is known to one skilled in the art, a macroblock is group of pixels used in the process of video compression. In FIG. 5 each blank macroblock, such as macroblock 502, denotes a macroblock which is fully coded with unique information. In the case of H. 264-coded video with the commonly used constraints (i.e., main profile) up to3200 bits (400 bytes) might be required to code each macroblock, although typically, significantly fewer bits are used. For illustrative purposes, it can be assumed that every blank macroblock within the original frame 500 could be coded using 48 bits (6 bytes). Alternatively, the macroblocks marked S, such as macroblock 504, represent a skip macroblock. A skip macroblock is one which requests that the receiving node execute a frame duplication operation, which is a form of error concealment. A macroblock coded as a skip might be coded using less than 1 bit. Unlike a coded macroblock which contains at least some independent information, a skip macroblock simply informs the decoding device to replace the skip macroblock with some information from the previously-decoded frame. In many instances, where the image being coded does not exhibit great variation, it is appropriate in the original coding of a frame to include certain skip macroblocks. However, there are other instances where an original macroblock is coded with unique information but the frame in which the macroblock is located has been given low priority. This could occur, for example, where the macroblock is part of a non-reference frame. As described in FIG. 3, when a congestion management unit determines that the network conditions require the reduction of the bitrate for a given datastream, the data portion of a bi-directional frame is often altered. One technique for reducing the bitrate of a datastream is to drop certain packets in order to alleviate network congestion. As described above, for many set top boxes that are not intelligent enough to handle missing packets, a dropped packet could cause the device to crash or hang up. FIG. 5 illustrates a method of altering the data portion of an original packet by coding all macroblocks within a modified frame 506 as skips. By doing so, the receiving node repeats a previous frame's data values for each macroblock within the modified frame 506. Despite the fact that this method 500 does result in the loss of some coded macroblocks 502, the overall effect of substituting skip macroblocks for coded macroblocks in low priority packets has been shown, in certain circumstances, to have minimal effect on the quality of service. In addition to reducing the overall size of a given frame, all receiving nodes are adequately equipped to handle a modified frame comprised entirely of skip macroblocks. Given that original frames 500 often use skip macroblocks 504, the receiving node will not be able to detect that modified frame 506 is an altered frame. When processing a modified frame 506, the receiving node will not be able to differentiate between an original frame which has been coded with all skip macroblocks and a modified frame 506, which has been altered to contain all skip macroblocks. Given the difference between the number of bits required to code the original frame 500 and the number of bits required to code the modified frame 506 this process of modifying frames can greatly reduce the bitrate of a datastream.

Although somewhat unlikely, is it possible that the bit pattern which represents an original unaltered packet could be identical to the bit pattern of a altered packet A packet which is identical to an altered packet is referred to as a “compact packet.” Even when network congestion levels would normally dictate altering the data field of a packet, the number of bits in a compact packet would already represent the lowest possible number. Therefore, when the goal is simply to reduce the bitrate of a datastream, there is no advantage to altering a compact packet. However there are other valid reasons for altering the content of a compact packet. By slightly altering the content of a compact packet, a congestion management unit could send an embedded signal to a receiving node indicating that some form of enhanced error concealment should be utilized. This example does not act to limit the inclusion of other possible reasons for altering a compact packet which would be obvious to one skilled in the art.

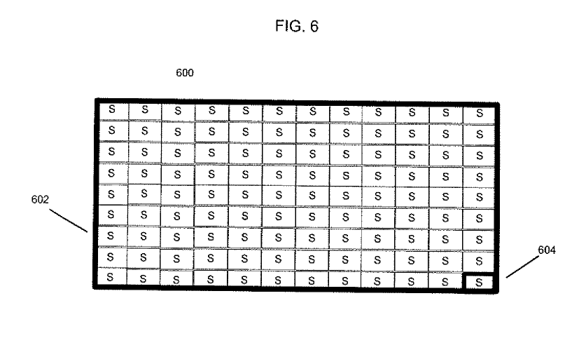

With reference to FIG. 6, a method is shown by which a congestion management unit can signal the presence of a compact packet. The incoming packet 600 is comprised completely of skip coded macroblocks. The packet 600 is first segmented into two slices. The major slice 602 which comprises a large portion of the packet and the minor slice 604 which consists of a small sequence of bits at the end of the packet. The major slice 602 remains unaltered. The congestion management unit alters the minor slice 604 slightly, while still ensuring that the packet complies with protocol standard. By altering the minor slice 604, the packet is now embedded with information which an “intelligent” receiving node can interpret. An intelligent receiving node can detect that a compact packet is present and then utilize more advanced error correction methods to generate a higher quality picture. In addition, given that the coding within the minor slice 604 complies with an appropriate encoding standard, older legacy receiving nodes will not be negatively effected by an alteration to the minor slice 604.

In addition to the embodiments described above, an embodiment of the present invention could be used to reduce the bitrate of a datastream which is transmitted to a data storage device. As described above, the bitrate of a video datastream which is being transmitted to a data storage deceive, could be reduced in order to allow for more efficient data storage.

One skilled in the art will appreciate that the present invention can be practiced by other than the described embodiments, which are present for purposes of illustration and not by way of limitation, and the present invention is limited only by the claims that follow.

What is claimed is:

1. A method of managing a datastream on a data network, the method comprising:
receiving a data packet, the data packet comprising header information and a data payload;
determining a priority level of the data packet;
determining a congestion level of the data network;
replacing the data payload with a shorter data payload, to form a modified data packet;
and
forwarding the modified data packet.

2. The method of claim 1, wherein the priority level of the data packet is based on an importance of the packet in the process of creating a desired output.

3. The method of claim 1, wherein the congestion level of the network is based on the amount of data present in a queue associated with a given output line.

4. The method of claim 1, wherein the shorter data payload includes data which triggers error concealment functionality within the receiving node.

5. The method of claim 1, wherein the datastream comprises a video sequence.

6. The method of claim 1, wherein the datastream comprises a video sequence and the shorter data payload includes a skip instruction.

7. A method of managing a datastream on a data network, the method comprising:
receiving a data packet, the data packet comprising header information and a data payload;
determining a priority level of the data packet;
determining a congestion level of the network;
if the congestion level is below a predetermined congestion level, forwarding the data packet; and
if the congestion level is greater than the predetermined congestion level;
replacing the data payload with a shorter data payload, to form a modified data packet; and
forwarding the modified data packet.

8. The method of claim 7, wherein the priority level of the data packet is based on an importance of the packet in the process of creating a desired output.

9. The method of claim 7, wherein the congestion level of the network is based on the amount of data present in a queue associated with a given output line.

10. The method of claim 7, wherein the predetermined congestion level is a function of the priority level of the packet and the level on congestion within the data network.

11. The method of claim 7, wherein the shorter data payload includes data which triggers error concealment functionality within the receiving node.

12. The method of claim 7, wherein the datastream comprises a video sequence.

13. The method of claim 7, wherein the datastream comprises a video sequence and the shorter data payload includes a skip instruction.

14. The method of claim 7, wherein the priority level of the data packet is based on an importance of the packet in the process of creating a desired output;
the congestion level of the network is based on the amount of data present in a queue associated with a given output line;
the predetermined congestion level is a function of the priority level of the packet and the level on congestion within the data network;
the shorter data payload includes data which triggers error concealment functionality within the receiving node; and
the datastream comprises a video sequence.

15. An apparatus for managing a datastream on a data network comprising:
a packet analysis module, configured to receive a data packet, the data packet comprising header information and a data payload, and determine a priority level of the data packet;
a congestion analysis module configured to determine a congestion level of the network;
a packet generation module, configured to:
forward the data packet if the congestion level is below a predetermined congestion level;
replace the data payload with a shorter data payload, to form a modified data packet, if the congestion level is greater than the predetermined congestion level; and
forward the modified data packet.

16. The apparatus of claim 15, wherein the priority level of the data packet is based on an importance of the packet in the process of creating a desired output.

17. The apparatus of claim 15, wherein the congestion level of the network is based on the amount of data present in a queue associated with a given output line.

18. The apparatus of claim 15, wherein the predetermined congestion level is a function of the priority level of the packet and the level on congestion within the data network.

19. The apparatus of claim 15, wherein the shorter data payload includes data which triggers error concealment functionality within the receiving node.

20. The apparatus of claim 15, wherein the datastream comprises a video sequence.

21. The apparatus of claim 15, wherein the priority level of the data packet is based on an importance of the packet in the process of creating a desired output;
the congestion level of the network is based on the amount of data present in a queue associated with a given output line;
the predetermined congestion level is a function of the priority level of the packet and the level on congestion within the data network;
the shorter data payload includes data which triggers error concealment functionality within the receiving node; and
the datastream comprises a video sequence.

22. A method of managing a datastream, comprising:
receiving a data packet, the data packet comprising header information and a data payload;
determining a priority level of the data packet;
replacing the data payload of the data packet with a shorter data payload, to form a modified data packet; and
forwarding the modified data packet.

23. The method of claim 22, where the modified packet is forwarded to a data storage device.

24. A apparatus for managing a datastream, comprising:
a packet analysis module, configured to receive a data packet, the data packet comprising header information and a data payload, and determine a priority level of the data packet;
a packet generation module, configured to:
replacing the data payload with a shorter data payload, to form a modified data packet; and
forwarding the modified data packet.

25. The apparatus of claim 24, where the modified packet is forwarded to a data storage device.
